(19) United States
(12) Patent Application Publication
(10) Pub. No.: US 2007/0165498 A1
(43) Pub. Date: Jul. 19, 2007

(54) Information reproducing apparatus and information reproducing method

(76) Inventor: Koji Maruyama, Akishima-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/640,209

(22) Filed: Dec. 18, 2006

(30) Foreign Application Priority Data
Dec. 19, 2005 (JP) 2005-365080

(51) Int. Cl. G11B 7/00

(52) U.S. Cl. 369/44.27; 369/44.25

(57) ABSTRACT

According to one embodiment, an information reproducing apparatus and method which is able to determine the type of and the standard for a disc on the basis of predetermined priorities, includes an optical head including a light source unit which outputs either first laser light or second laser light having a wavelength different from that of the first light, and a notice processing section which outputs display information indicating that the disc is compatible with the wavelength of the first laser light when the tracking error signal exceeds the predetermined threshold and which outputs display information indicating that the disc is compatible with the wavelength of the second laser light when the tracking error signal does not exceed the predetermined threshold.

### CROSS-REFERENCE TO RELATED APPLICATIONS

This application is based upon and claims the benefit of priority from Japanese Patent Application No. 2005-365080, filed Dec. 19, 2005, the entire contents of which are incorporated herein by reference.

### BACKGROUND

1. Field

One embodiment of the invention relates to an information reproducing apparatus and method for reproducing information recorded in, for example, a digital versatile disc (DVD), or a high definition DVD (HD DVD).

2. Description of the Related Art

In recent years, DVDs and their reproducing apparatuses have prevailed and HD DVDs have been developed which enable high density recording or high image quality recording. For these developed optical discs, which conform to different standards, reproducing apparatuses have been desired which can singularly deal with various discs. Such a reproducing apparatus is disclosed in Japanese Patent Application Publication (KOKAI) No. 9-44984.

Even if various discs conforming to different standards are set in the reproducing apparatus described in this document, it is able to reproduce information from all of these discs except those meeting particular standards. This reproducing apparatus thus has a function for determining the standard for and the type of a disc set in the apparatus.

Top of contents (TOC) recorded in the disc is read and the disc is identified on the basis of identification information described in TOC. The identified disc type is displayed on a monitor connected to the apparatus.

However, reading TOC requires a procedure of reading information described in the disc, executing processing such as error corrections, demodulating data, and allowing an information processing section to analyze the read information. This increases the amount of time from setting of the disc until the determination of the disc type.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary diagram showing an example of an information reproducing apparatus according to an embodiment of the invention;

FIG. 2 is an exemplary diagram showing an example of a basic configuration of the information reproducing apparatus shown in FIG. 1, according to an embodiment of the invention;

FIG. 3 is an exemplary diagram showing examples of the relationship between the wavelength of a light source and the type of and the standard for the disc and a focus error signal, according to an embodiment of the invention;

FIG. 4 is an exemplary diagram showing an example of a focus error signal output from the information reproducing apparatus shown in FIG. 1, according to an embodiment of the invention;

FIG. 5 is a flowchart showing an example of operation of the information reproducing apparatus shown in FIG. 1, according to an embodiment of the invention;

FIGS. 6A to 6F are exemplary diagrams, each showing an example of a displayed screen of the information reproducing apparatus shown in FIG. 1, according to an embodiment of the invention;

FIG. 7A is an exemplary diagram showing an example of a display panel of the information reproducing apparatus shown in FIG. 1, according to an embodiment of the invention; and

FIG. 7B is an exemplary diagram showing an example of a display example of the display panel shown in FIG. 7A, according to an embodiment of the invention.

### DETAILED DESCRIPTION

Various embodiments according to the invention will be described hereinafter with reference to the accompanying drawings. In general, according to one embodiment of the invention, an information reproducing apparatus and method which is able to determine the type of and the standard for a disc on the basis of predetermined priorities, includes an optical head including a light source unit which outputs either first laser light or second laser light having a wavelength different from that of the first light, and a notice processing section which outputs display information indicating that the disc is compatible with the wavelength of the first laser light when the tracking error signal exceeds the predetermined threshold and which outputs display information indicating that the disc is compatible with the wavelength of the second laser light when the tracking error signal does not exceed the predetermined threshold.

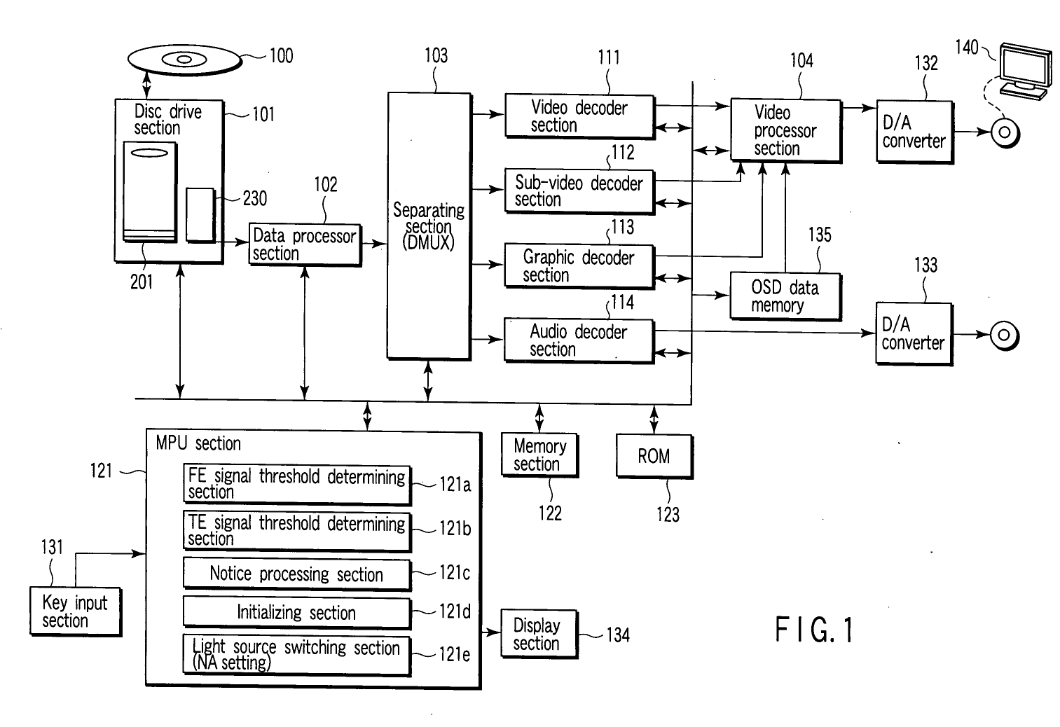

According to an embodiment, information recorded in an optical disc 100 shown in FIG. 1 is read by a disc drive section 101. The information read by the disc drive section 101 is supplied to a data processor section 102. The information is demodulated and subjected to error corrections. The resultant information is then stored in a track buffer (not shown) in the data processor section 102.

Among the information stored in the track buffer, management information is stored in a memory section 122 and utilized for reproduction control and data management. Further, among the information stored in the track buffer, information as video objects is input to a separating section 103. The separating section 103 separates the information into a video pack, a graphic unit pack, an audio pack, a sub-video pack, a navigation pack, and the like.

The video pack is input to a video decoder section 111, and the sub-video pack is input to a sub-video decoder section 112. The graphic pack is input to a graphic decoder section 113, and the audio pack is input to an audio decoder section 114. All these packs are then decoded. The navigation pack and the like, which contain control information, is input to a micro processing unit (MPU) section 121.

A video processor section 104 is supplied with main video information resulting from the decoding process of the video decoder section 111, sub-video information resulting from the decoding process of the sub-video decoder section 112, and graphic information resulting from the decoding process of the graphic decoder section 113. These pieces of information are then subjected to a superimposing process by the video processor section 104. The resultant information is converted by a D/A (Digital/Analog) converter 123 into analog information, which is then supplied to a display device 140.

Sound (audio) information decoded by the decoding process of the audio decoder section 114 is converted by a D/A converter 113 into a sound signal, which is then output to a speaker.

An OSD data memory 135 is also provided. The output of display data from the ODS data memory 135 is controlled by an MPU section 121. The display of this data will be described below in detail.

The MPU section 121 integrally controls the operation of each section. The MPU section 121 receives operation information from a key input section 131 and controls each section on the basis of programs stored in a ROM section 123. A display section 134 displays an operation status and the likes.

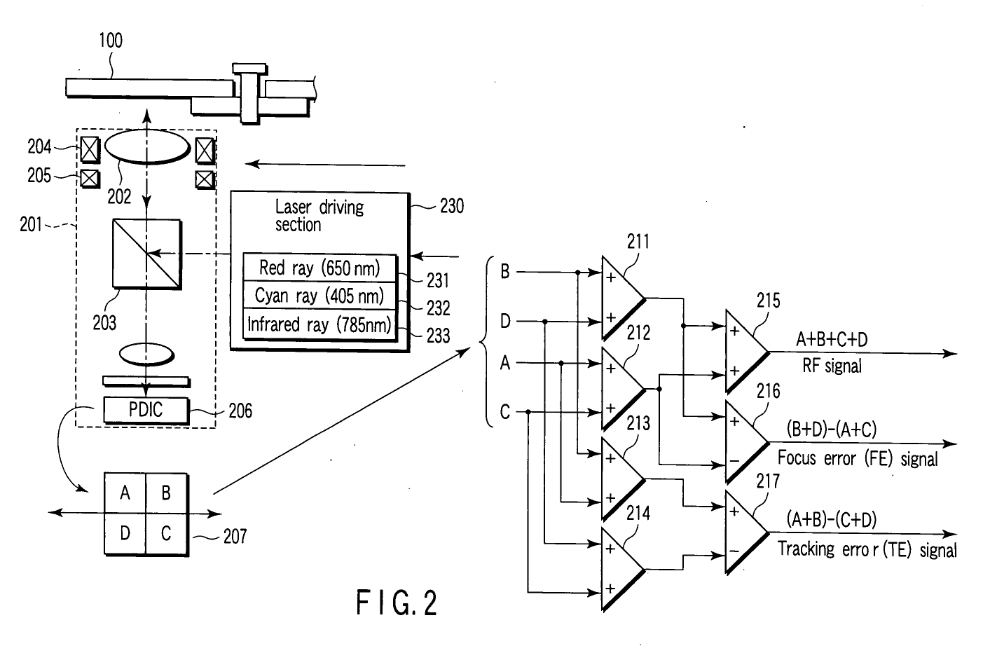

FIG. 2 shows typical components of the disc drive section 101, including an optical head device 201. The optical head device 201 has an optical system including an objective lens 202, a beam splitter 203, a focus actuator 204, a tracking actuator 205 and a laser driving section 230.

A laser beam from one of light sources 231 and 232 is selected by a laser driving section 230 is incident on the beam splitter 203. The laser light source 231 outputs laser beam of wavelength 650 nm (red ray), which is compatible with DVD. The laser light source 232 outputs laser beam of wavelength 405 nm (cyan ray), which is compatible with HD DVD. A third laser light source 233 outputs laser beams of wavelength 785 nm (infrared ray), which is compatible with CD. The selection of the light source is carried out in accordance with an instruction from the MPU section 121.

A laser beam reflected by the beam splitter 203 is condensed by the objective lens 202 and focused to a recording surface of the optical disc 100. A laser beam reflected by the optical disc is guided to a photo detector circuit 206. In the photo detector circuit 206, for example, four divided diodes A, B, C, and D are arranged in a photo detecting section 207.

A laser beam detected by the photo detecting section 207 is converted into an electric signal, which is then input to adders 211, 212, 213, and 214. Outputs from the adders 211 and 212 are input to an adder 215. An output from the adder 215 is an RF signal (reproduction signal). Outputs from the adders 211 and 212 are input to a subtractor 216. An output from the subtractor 216 is used as a focus error signal (FE signal). Outputs from the adders 213 and 214 are input to a subtractor 217. An output from the subtractor 217 is used as a tracking error signal (TE signal)

The MPU section 12 uses the focus error signal and tracking error signal to control the focus actuator 204 and tracking actuator 205 of the optical head device 201. This control allows a beam focus to be placed on a certain track in the optical disc and also enables a tracking on operation.

FIG. 3 shows examples of detected focus error signals. As described above, the apparatus according to the preset invention switches the plurality of laser switches with the different wavelengths according to the type of the disc. Accordingly, the output level of the focus error signal varies depending on the relationship between the loaded disc and the light source used. FIG. 3 shows examples of combinations of the disc and the light source used as well as the resulting focus error signal (EF signal).

Description will be given of results of the use of the first light source 231 and the settings of a wavelength of 650 nm and NA=0.65. An FE signal 301 is obtained when the disc is DVD. The FE signal 301 of 0 indicates just focus. Longitudinal movement of the objective lens (control of movement along the thickness the disc) results in a focus error signal with S-shaped curve characteristics. In this case, the maximum value MAX exceeds a threshold Th1. An FE signal 302 is obtained when the disc is HD DVD. The FE signal 302 of 0 indicates just focus. Also in this case, the maximum value MAX for the S-shaped curve characteristics exceeds the threshold Thl. An FE signal 303 is obtained when the disc is CD. The FE signal 303 of 0 indicates just focus. In this case, the maximum value MAX for the S-shaped curve characteristic does not exceed the threshold Thl. An FE signal 304 is obtained when the disc is a Blu-ray disc BD. The FE signal 304 of 0 indicates just focus. Also in this case, the maximum value MAX for the S-shaped curve characteristic does not exceed the threshold Thl.

Description will be given of results of the use of the second light source 232 and the settings of a wavelength of 405 nm and NA=0.65. An FE signal 311 is obtained when the disc is DVD. The maximum value MAX for the S-shaped curve characteristics exceeds a threshold Th2. An FE signal 312 is obtained when the disc is HD DVD. Also in this case, the maximum value MAX for the S-shaped curve characteristics exceeds the threshold Th2. An FE signal 313 is obtained when the disc is CD. The maximum value MAX for the S-shaped curve characteristic does not exceed the threshold Th2. An FE signal 314 is obtained when the disc is a Blu-ray disc BD. Also in this case, the maximum value MAX for the S-shaped curve characteristic does not exceed the threshold Th2.

When the second light source 232 is similarly used with the wavelength set at 405 nm but NA=0.85 is set, the following results are obtained. An FE signal 321 is obtained when the disc is DVD. The maximum value MAX for the S-shaped curve characteristics does not exceed a threshold Th3. An FE signal 322 is obtained when the disc is HD DVD. Also in this case, the maximum value MAX for the S-shaped curve characteristics does not exceed the threshold Th3. An FE signal 323 is obtained when the disc is CD. Also in this, the maximum value MAX for the S-shaped curve characteristic does not exceed the threshold Th3. An FE signal 324 is obtained when the disc is a Blu-ray disc BD. In this case, the maximum value MAX for the S-shaped curve characteristic significantly exceeds the threshold Th3.

With the FE signal monitored as described above, DVD, HD DVD, and the other discs (CD and BD) can be identified by using the first light source 231 or second light source 232 and setting a wavelength of 650 nm and NA=0.65.

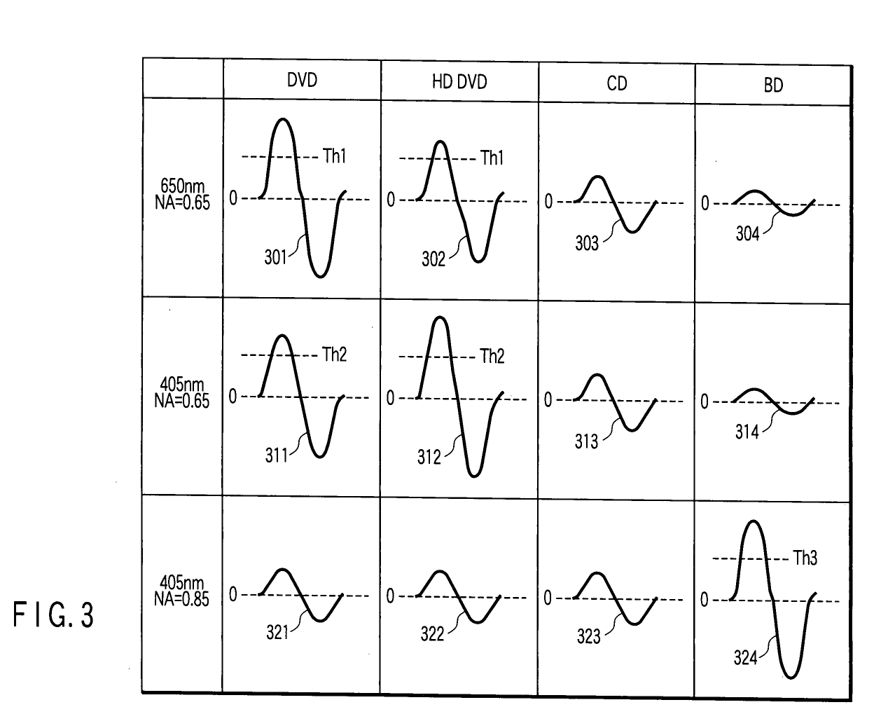

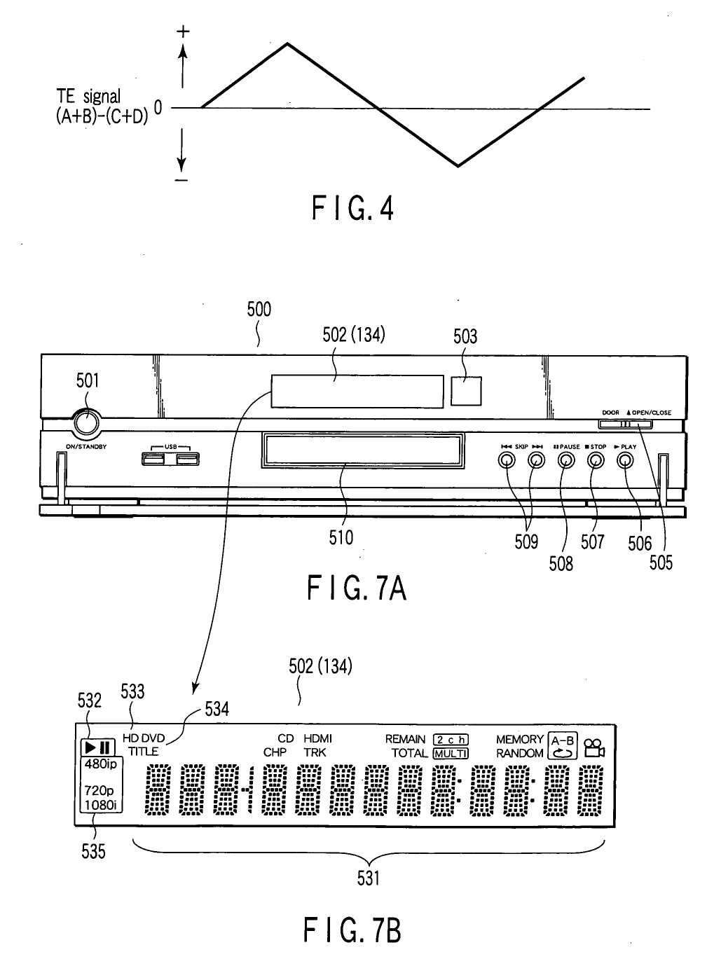

To distinguish DVD and HD DVD from each other, for example, the tracking error signal (TE signal) is used. HD DVD has a track pitch of 0.4 μm and DVD has a track pitch of 0.74 μm. Accordingly, the HD DVD is loaded, wobbling beams of wavelength 650 nm along the tracks results in a tracking error signal of almost a DC level. However, the HD DVD is loaded, wobbling beams of wavelength 405 nm along the tracks varies the tracking error signal as shown in FIG. 4. Specifically, the level of the tracking error signal increases and decreases from a track on status (level 0). Further, the DVD is loaded, wobbling beams of wavelength 650 nm along the tracks varies the tracking error signal as shown in FIG. 4. However, the DVD is loaded, wobbling beams of wavelength 405 nm along the tracks results in a tracking error signal of almost the DC level. Consequently, DVD and HD DVD can be distinguished from each other by determining whether or not a tracking error signal is correctly obtained.

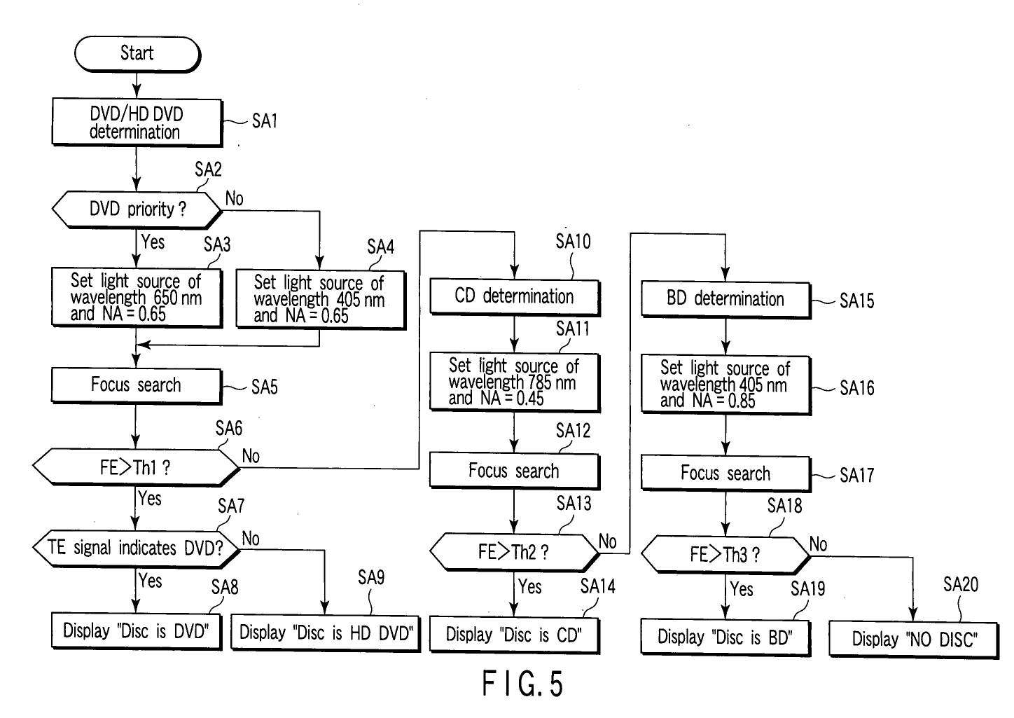

FIG. 5 is a flowchart showing an example of operation of the apparatus according to the invention which operates on the above settings and the nature of the FE and TE signals. Before describing the flowchart, description will be given of functions of each section of the MPU section 121 in FIG. 1 which implement the process shown in the flowchart.

The determination for the FE signal is made by an FE signal threshold determining section 121a of the MPU section 121. The determination for the TE signal is made by a TE signal threshold determining section 121b of the MPU section 121. A notice processing section 121c of the MPU section 121 notifies the OSD data memory 135 of a determination status and the like. In response to this, the OSD data memory 135 outputs display data to display a screen on the display device 140 via the video processor 104. An initializing section 121d determines whether the disc DVD or HD DVD is given priority in the first search. A light source switching section 121e functions when the light source needs to be switch during disc distinction.

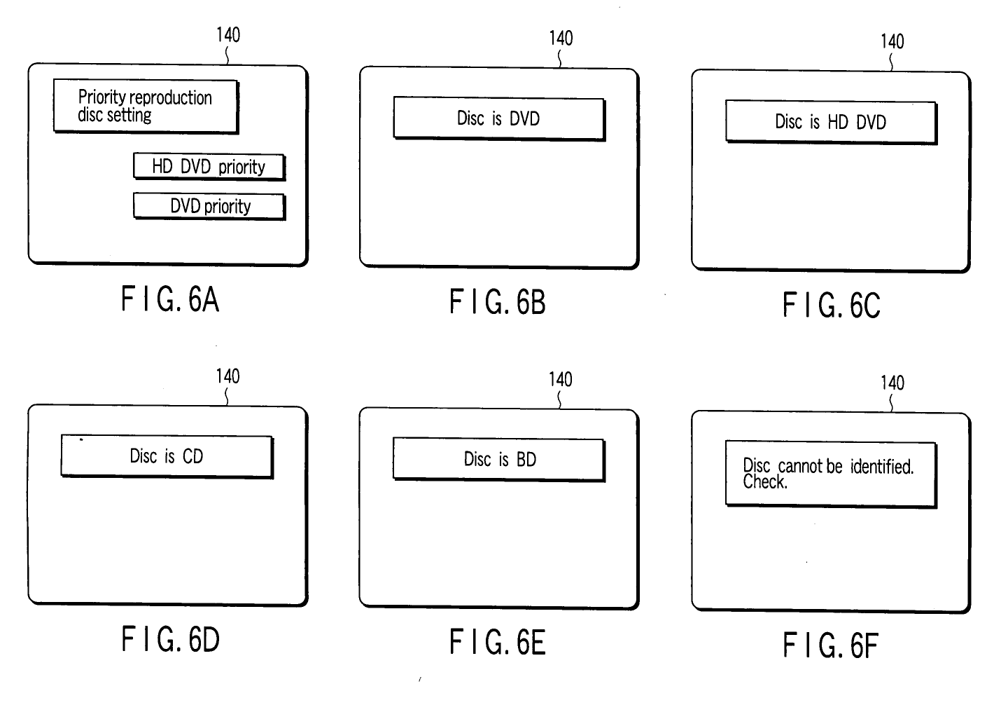

Referring to FIG. 5, once the disc is loaded and a disc distinguishing operation is started (step SA1), the apparatus checks the settings to determine whether DVD or HD DVD is given priority. That is, this apparatus can set in initialization whether DVD or HD DVD is to be subjected to determination earlier. If DVD is given priority, then a wavelength of 650 nm and NA=0.65 are set in the optical head apparatus. If HD DVD is given priority, then a wavelength of 405 nm and NA=0.65 are set in the optical head apparatus. These settings are made by the initializing section 121d. A display screen in FIG. 6A shows a setting screen for initialization. For example, the priorities can be set by, for example, operating a remote controller, selecting “HD DVD priority” or “DVD priority” via a cursor, and depressing an entry button.

In step SA2 in FIG. 5, the apparatus determines that DVD priority is set (step SA3). The reason for this setting is as follows. When the type of one of many discs owned by the user is to be determined and if the user has many DVDs, disc distinction is achieved more quickly by setting DVD priority. If HD DVD priority is set instead of DVD priority, the optical head apparatus sets a wavelength of 405 nm and NA=0.65 (step SA4).

Then, a focus search is started as previously described (step SAS). The apparatus determines whether or not the FE signal exceeds the threshold Th1 (step SA6). If the FE signal threshold determining section 121a determines that the threshold Th1 is exceeded, then the TE signal is utilized. If the TE signal threshold determining section 121b determines that the TE signal corresponding to the set disc has been obtained, then the disc type is determined. For example, in the above embodiment, if the TE signal is obtained as shown in FIG. 4, the disc is determined to be DVD (steps SA7 and SA8). A notice of the need for screen display is thus given. This notice is given to the OSD data memory 135 by the notice processing section 121c, shown in FIG. 1. The resulting screen display is as shown in FIG. 6B. If the TE signal has not been obtained as shown in FIG. 4 (substantially low noise level), the apparatus determines the disc to be HD DVD (steps SA7 and SA9). A notice of the need for screen display is thus given. The resulting screen display is as shown in FIG. 6C.

If in step SA6, the FE signal does not exceed the threshold, the currently loaded disc may be CD or BD. Thus, the apparatus shifts to a CD determining process (step SA10) to switch to the status of use of the third light source 233. The switching is executed by a light source switching section 121e. A wavelength of 785 nm and NA=0.45 are set. Then, a focus search is started to determine whether or not the FE signal exceeds the threshold Th2 (steps SA12 and SA13).

If the FE signal exceeds the threshold Th2, the corresponding determination is communicated to the OSD data memory 135 by the notice processing section 121c. A display screen (FIG. 6D) is obtained which shows that the disc is CD. In step SA13, if the FE signal does not exceed the threshold Th2, a BD determination is started (step SA15). Te second light source 232 is set. However, in this case, NA=0.85 is set (step SA16).

Then, a focus search is started (step SA17). The apparatus determines whether or not the FE signal exceeds the threshold Th3 (step SA18).

If the FE signal exceeds the threshold Th3, the corresponding determination is communicated to the OSD data memory 135 by the notice processing section 121c. A display screen (FIG. 6E) is obtained which shows that the disc is BD. In step SA13, if the FE signal does not exceed the threshold Th3, the disc type cannot be determined or no disc is loaded. A warning screen is thus obtained (FIG. 6F).

In the above description, the type of the loaded disc is displayed by the display device 140. However, the embodiment is not limited to this, since the disc type may be orally output or displayed by the display section 134 of the apparatus main body.

FIG. 7A is a front view of an information reproducing apparatus 500 to which of one embodiment of the invention is applied. In the front view of the information reproducing apparatus 500, a power on/off button 501, a display window 502 (corresponding to the display section 134), a remote control receiving section 503 and a door open/close operation instruction button 505 are arranged. In the front view of the information reproducing apparatus 500, a reproducing operation start instruction button 506, and a stop operation instruction button 507, a pause operation instruction button 508, and a skip operation instruction button 509 are further arranged. A disc tray 510 is projected or retracted in response to the operation of the door open/close button 505, and so as to allow disc replacement or the like.

As shown in FIG. 7B, the display window 502 includes, for example, a segment display section 531 and can display total disc reproduction time, elapsed time, remaining amount, title, and the like. A status display section 532 can shows whether the apparatus is performing a reproducing operation, is stopped, or is paused. A disc identification display section 533 can show what disc is loaded in the apparatus (DVD, HD DVD, or the like). A title display section 534 can display title numbers. Further, 535 can display the resolution of a currently output video. As described above, viewing the disc identification display section 533 of this apparatus enables the easy determination of what disc is loaded in the apparatus.

The apparatus according to the one embodiment of the invention is able to adapt for a single-side one-layer DVD, a single-side one-layer HD DVD, a single-side two-layer DVD, a single-side two-layer HD DVD, a double-side DVD, a double-side HD DVD, a double-side disc has an one-side DVD and other-side HD DVD, and the like.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An information reproducing apparatus comprising:
an optical system including at least a first laser light source and a second laser light source which have different wavelengths and an objective lens which irradiates an optical disc with laser light from the first light source or second light source, the optical system guiding reflected light from the optical disc to a photo detector circuit;
an optical head including a focus actuator which adjusts a position of the objective lens in a direction of an optical axis for focus control (in order to control a focus of the objective lens);
a focus error signal threshold determining section which determines whether or not a focus error signal output by the photo detector circuit exceeds a predetermined threshold while the first light source is in use;
a tracking error signal threshold determining section which, when the focus error signal exceeds the predetermined threshold, determines whether or not a tracking error signal output by the photo detector circuit exceeds a predetermined threshold; and
a notice processing section which outputs display information indicating that the disc is compatible with the first light source when the tracking error signal exceeds the predetermined threshold and which outputs display information indicating that the disc is compatible with the second light source when the tracking error signal does not exceed the predetermined threshold.

2. The information reproducing apparatus according to claim 1, wherein the first laser source is compatible with DVD and has a wavelength of 650 nm, and second laser source is compatible with HD DVD and has a wavelength of 405 nm.

3. The information reproducing apparatus according to claim 1, wherein the notice processing section specifies output data from an onscreen display data memory in which display data is pre-stored.

4. The information reproducing apparatus according to claim 1, further comprising:
an initializing section configured to arbitrarily switch, for initialization, between the first laser source which is compatible with DVD and which has a wavelength of 650 nm and the second laser source which is compatible with HD DVD and which has a wavelength of 405 nm, by giving priority to either the first light source or the second light source.

5. The information reproducing apparatus according to claim 1, further comprising:
a third laser source which is compatible with CD and which has a wavelength of 785 nm; and
a light source switching section which, when the tracking signal does not exceed the predetermined threshold while the first light source or second light source is in use, switches to a status of use of the third laser light source.

6. The information reproducing apparatus according to claim 1, further comprising:
a third laser source which is compatible with CD and which has a wavelength of 785 nm; and
a light source switching section which, when the tracking signal does not exceed the predetermined threshold while the first light source or second light source is in use, switches to a status of use of the third laser light source and which, when the tracking signal does not exceed a predetermined second threshold while the third light source is in use, uses the second light source of wavelength 405 nm and sets NA of the objective lens at 0.85.

7. An information reproducing method using an information reproducing apparatus having an optical system including at least a first laser light source and a second laser light source which have different wavelengths and an objective lens which irradiates an optical disc with laser light from the first light source or second light source, the optical system guiding reflected light from the optical disc to a photo detector circuit, an optical head device including a focus actuator which adjusts the objective lens in a direction of an optical axis for focus control, an information processing section which processes information output by the optical head device, and a control section which uses information output by the optical head device, the method comprising:
determining whether or not a focus error signal output by the photo detector circuit exceeds a predetermined threshold while the first light source is in use, when the focus error signal exceeds the predetermined threshold, determining whether or not a tracking error signal output by the photo detector circuit exceeds a predetermined threshold; and
outputting display information indicating that the disc is compatible with the first light source when the tracking error signal exceeds the predetermined threshold and outputting display information indicating that the disc is compatible with the second light source when the tracking error signal does not exceed the predetermined threshold.

8. The information reproducing method according to claim 7, wherein the method is configured to arbitrarily switch between the first laser source which is compatible with DVD and which has a wavelength of 650 nm and second laser source which is compatible with HD DVD and which has a wavelength of 405 nm.

9. The information reproducing method according to claim 7, wherein the optical head device further has a third laser source which is compatible with CD and which has a wavelength of 785 nm, when the tracking signal does not exceed the predetermined threshold while the first light source or second light source is in use, a status is switched to the use of the third laser light source.

10. The information reproducing method according to claim 7, wherein the optical head device further has a third laser source which is compatible with CD and which has a wavelength of 785 nm, when the tracking signal does not exceed the predetermined threshold while the first light source or second light source is in use, a status is switched to the use of the third laser light source, and when the tracking signal does not exceed a predetermined second threshold while the third light source is in use, the second light source of wavelength 405 nm is used and NA of the objective lens is set at 0.85.
